(19) United States
(12) Patent Application Publication
(10) Pub. No.: US 2025/0389751 A1
(43) Pub. Date: Dec. 25, 2025

(54) MEASUREMENT SYSTEM AND MEASUREMENT METHOD

(71) Applicant: Gtheranostics Co., Ltd., Tokyo (JP)

(72) Inventors: Hidemi SHIGEKAWA, Tsukuba-shi (JP); Hiroyuki MOGI, Tsukuba-shi (JP)

(21) Appl. No.: 19/204,959

(22) Filed: May 12, 2025

(30) Foreign Application Priority Data
May 14, 2024 (JP) 2024-078902

(51) Int. Cl. G01Q 60/40

(52) U.S. Cl. CPC G01Q 60/40

(57) ABSTRACT

A measurement system includes: a first laser device for outputting a pump light as a pulse laser in response to an input first signal; a second laser device for outputting a probe light as a pulse laser in response to an input second signal; a trigger generator and delay time controller for inputting the first signal and the second signal to the first laser and the second laser, repeatedly inputting the first signal and the second signal by switching a variable delay value which is a difference between a timing of inputting the first signal to the first laser and a timing of inputting the second signal to the second laser in a plurality of ways, and outputting a reference signal to a lock-in amplifier when switching the variable delay value; an auxiliary optical system for guiding the pump light and the probe light to sample; a cantilever having an probe tip disposed proximate to the sample; and a controller for applying a periodically varying voltage to the cantilever and outputting a change amount signal which is a voltage or a current corresponding to a change in the resonance frequency of the cantilever, wherein the lock-in amplifier measures the change amount signal based on reference signal.

### TECHNICAL FIELD

The present invention relates to a measurement system and a measurement method.

### BACKGROUND ART

STM (Scanning Tunneling Microscope) can obtain information such as conductivity, but the measurement target is limited to a conductive object. AFM (Atomic Force Microscope) is generally easier to handle than STM, and is widely used as a means for observing the surface of sample. In JP 2022-89945 A, a method for determining mechanical properties of a soft viscoelastic sample using an atomic force microscope (AFM) based system is disclosed.

### CITATION LIST

### Patent Literature

Patent Literature 1: JP 2022-89945 A

### SUMMARY OF INVENTION

### Technical Problem

The invention described in JP 2022-89945 A cannot measure photoexcitation dynamics.

### Solution to Problem

According to the 1st aspect of the present invention, a measurement system includes: a first laser device for outputting a pump light as a pulse laser in response to an input first signal; a second laser device for outputting a probe light as a pulse laser in response to an input second signal; a trigger generator and delay time controller for inputting the first signal and the second signal to the first laser and the second laser, repeatedly inputting the first signal and the second signal by switching a variable delay value which is a difference between a timing of inputting the first signal to the first laser and a timing of inputting the second signal to the second laser in a plurality of ways, and outputting a reference signal to a lock-in amplifier when switching the variable delay value; an auxiliary optical system for guiding the pump light and the probe light to sample; a cantilever having an probe tip disposed proximate to the sample; and a controller for applying a periodically varying voltage to the cantilever and outputting a change amount signal which is a voltage or a current corresponding to a change in the resonance frequency of the cantilever, wherein the lock-in amplifier measures the change amount signal based on reference signal.

According to the 2nd aspect of the present invention, a measuring method executed by a measuring system includes a first laser device for outputting pump light which is a pulse laser in response to a first signal inputted thereto, a second laser device for outputting probe light which is a pulse laser in response to a second signal inputted thereto, an auxiliary optical system for guiding the pump light and the probe light to a sample, a cantilever having probe tip disposed in proximity to the sample, and lock-in amplifier, the measuring method includes: inputting the first signal and the second signal to the first laser device and the second laser device, respectively; repeatedly inputting the first signal and the second signal by switching a variable delay value, which is a difference between a timing at which the first signal is input to the first laser device and a timing at which the second signal is input to the second laser, to a plurality of values; and outputting a reference signal to the lock-in amplifier when switching the variable delay value; and applying a periodically varying voltage to the cantilever and outputting a change amount signal which is a voltage or a current corresponding to a change in a resonance frequency of the cantilever; measuring, by the lock-in amplifier, the change-amount signal by phase-sensitive detection using reference signal.

### Advantageous Effects of Invention

According to the present invention, the optical excitation dynamics can be measured only by adding light source unit to the existing microscope unit.

### BRIEF DESCRIPTION OF DRAWINGS

FIG. 1 is an overall configuration diagram of a measurement system according to a first embodiment.

FIG. 2 is a diagram illustrating processing of delay time controller,

FIG. 3 is a diagram illustrating a measurement example.

FIG. 4 is a diagram illustrating a light source unit according to a first modification;

FIG. 5 is a diagram illustrating a light source unit according to a second modification;

FIG. 6 is an overall configuration diagram of a measurement system according to a fifth modification.

FIG. 7 is an overall configuration diagram of a measurement system according to a second embodiment.

FIG. 8 is a diagram illustrating force spectroscopy.

FIG. 9 is a diagram showing an IV curve.

FIG. 10 is an overall configuration diagram of a measurement system according to a third embodiment.

FIG. 11 is a diagram illustrating output timing of reference pulse.

FIG. 12 is a diagram illustrating a problem that occurs when a frequency of reference pulse is not adjusted.

FIG. 13 is a diagram illustrating a problem that occurs when the phase of reference pulse is not adjusted.

### DESCRIPTION OF EMBODIMENTS

### First Embodiment

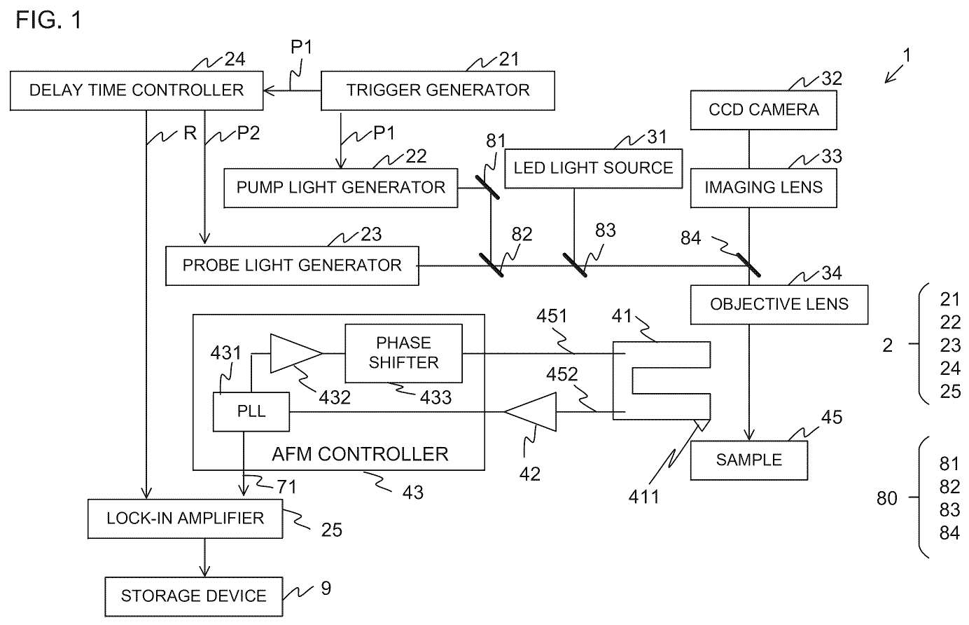

Hereinafter, a first embodiment of a measurement system will be described with reference to FIGS. 1 to 3.

FIG. 1 is an overall configuration diagram of a measurement system 1. The measurement system 1 includes light source unit 2, microscope unit 3, and AFM unit 4. AFM unit 4 including sample stage (not shown) has a known configuration, and the feature of measurement system 1 is that AFM unit 4 is combined with light source unit 2.

The light source unit 2 includes a trigger generator 21, a pump light generator 22, a probe light generator 23, a delay time controller 24, and a lock-in amplifier 25. The light source unit 2 is, for example, a delay time modulation excitation light source unit (OPP-PS or OPP-NS, UNISOK Co., Ltd.). Hereinafter, pump light generator 22 is also referred to as a “first laser device”, and probe light generator 23 is also referred to as a “second laser device”.

The microscope unit 3 includes a LED light source 31, a CCD camera 32, an imaging lens 33, and an objective lens 34. microscope unit 3 observes a sample 45 disposed on a sample platform (not shown). AFM unit 4 includes a tuning fork cantilever 41, a charge amplifier 42, an AFM controller 43, and a sample stage (not shown). A sample 45 is arranged in sample stage.

The configuration of light source unit 2 will be described. The trigger generator 21 outputs the set voltage pulse at a predetermined cycle set in advance, for example, at 1 MHz. The trigger generator 21 outputs the same voltage pulse to pump light generator 22 and delay time controller 24 at the same timing. Hereinafter, this voltage pulse is referred to as reference pulse P1.

The pump light generator 22 outputs a laser pulse according to the input voltage pulse, that is, reference pulse P1. When one voltage pulse is input, pump light generator 22 outputs one laser pulse. The time interval from the input of the voltage pulse to pump light generator 22 to the output of the laser pulse from pump light generator 22 is constant every time. In the present embodiment, a laser pulse output from pump light generator 22 is used as pump light.

The delay time controller 24 receives reference pulse P1 from trigger generator 21, outputs delay pulse P2 to probe light generator 23, and outputs reference signal R to lock-in amplifier 25. Upon receiving reference pulse P1, delay time controller 24 outputs delay pulse P2 with a delay of delay time td. delay time controller 24 periodically changes delay time td, and changes reference signal R at the timing of changing delay time td. That is, delay time controller 24 realizes delay time modulation.

There are two types of delay time td: measurement delay time and reference delay time. The measurement delay time is shorter than the relaxation process of the excited state of sample 45 by light, and reference delay time is longer than the relaxation time of the excited state of sample 45 excited by light. The reference delay time can also be said to be a time at which sample 45 excited by the pump light can be regarded as returning to the non-excited state again. Hereinafter, delay time td is also referred to as a “variable delay value”. The reference pulse P1 is also referred to as a “first signal”, and delay pulse P2 is also referred to as a “second signal”.

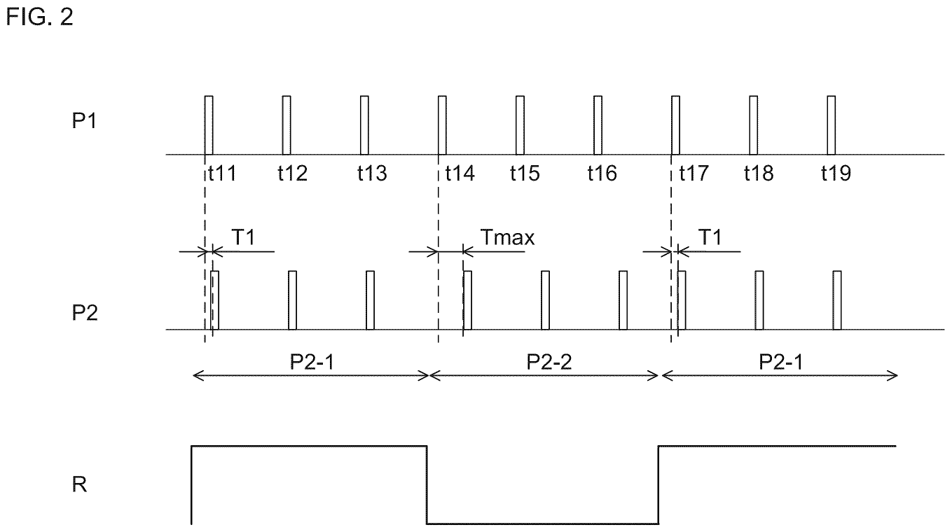

FIG. 2 is a diagram illustrating the processing of delay time controller 24, and illustrates the relationship between reference pulse P1, delay pulse P2, and reference signal R. In FIGS. 2, t11 to t19 are shown for convenience of explanation. The reference pulse P1 is output at each of time t11 to time t19 in a constant cycle. From time t11 to time t13, delay time controller 24 sets delay time td as a first time T1, which is a certain measurement delay time, and outputs a delay pulse P2 after a lapse of first time T1 from the reception of reference pulse P1. Hereinafter, delay pulse P2 to which measurement delay time is applied is also referred to as a first delay pulse P2-1.

The delay time controller 24 outputs the reference signal R as High, for example, 5 V from time t11 to time t13, and changes the reference signal R to Low, for example, 1 V after time t13. The timing of switching reference signal R is set in advance, for example, every predetermined time, every time reference pulse P1 is received a predetermined number of times, or every time delay pulse P2 is output a predetermined number of times. The delay time controller 24 changes delay time between the measurement delay time and reference delay time each time reference signal R is switched. The delay time controller 24 outputs delay pulse P2 after the lapse of Tmax, which is reference delay time, in response to reference pulse P1 received between time t14 and time t16. Hereinafter, delay pulse P2 to which reference delay time is applied is also referred to as a second delay pulse P2-2.

After time t16, delay time controller 24 switches the output of reference signal R from Low to High. Thereafter, delay time controller 24 outputs first delay pulse P2-1 with delay time td as T1 which is the measurement delay time, similarly to time t11 to time t13. Thereafter, delay time controller 24 switches the output of reference signal R in the same manner as after the time t13, and sets delay time td to Tmax. Note that FIG. 2 is simplified for convenience of drawing, and the number of times of outputting delay pulse P2 without changing delay time td is only three. However, the number of repetitions is actually very large. In the present embodiment, the measurement is performed by variously changing the short time of delay time td.

For example, in one measurement, delay time td is alternately set to T1 and Tmax, in another measurement, delay time td is alternately set to T2 and Tmax, and in yet another measurement, delay time td is alternately set to T3 and Tmax. T1, T2, and the like may be input to delay time controller 24 in advance, or may be set by communication from an external control device (not shown), for example, a general-purpose computer. Tmax may be set to a predetermined value in advance, or may be set each time as with T1 or the like.

In the example shown in FIG. 2, delay pulse P2 lags behind reference pulse P1, and such a state is defined as a positive value of delay time. When delay time td is set negative, delay pulse P2 precedes reference pulse P1. That is, when delay time is negative, sample 45 is irradiated with delay pulse P2 first, and then sample 45 is irradiated with reference pulse P1.

Returning to FIG. 1, the description will be continued. The probe light generator 23 outputs a laser pulse according to delay pulse P2 input from delay time controller 24. The configuration of probe light generator 23 is the same as that of pump light generator 22, but the input voltage pulse is different. In the present embodiment, since the laser pulse output from probe light generator 23 is used as the probe light, the name is merely different from that of pump light generator 22.

However, here, for convenience of explanation, pump light generator 22 and probe light generator 23 are the same, and the hardware configurations thereof may be different. The laser pulses output from pump light generator 22 and probe light generator 23 may or may not have the same wavelength or intensity. The laser pulses output from pump light generator 22 and probe light generator 23 have, for example, a wavelength of 532 nm and a pulse width of 45 ps. The pump light output from pump light generator 22 and the probe light output from probe light generator 23 are guided to the same optical path by mirror 81 and half mirror 82.

The LED light source 31 outputs illumination light for photographing by the CCD camera 32. The illumination light is guided to the same optical path as the pump light and the probe light by the short pass filter 83. The cutoff wavelength of short pass filter 83 is, for example, 550 nm. The CCD camera 32 photographs the sample 45 via imaging lens 33 and objective lens 34. However, the CCD camera 32 is provided for convenience of checking the sample 45, and is not an essential configuration for measurement described later. The short pass filter 83 may be appropriately changed depending on the wavelength of the light source 46 to be used and the purpose of observation. For example, a long pass filter or a half mirror may be used.

The sample 45 is irradiated with the pump light, the probe light, and the illumination light via the half mirror 84 and the objective lens 34. As described above, since the CCD camera 32 is not an essential component for the measurement described later, the role of the microscope unit 3 in the measurement is to hold the sample 45 and guide the pump light and the probe light to the sample 45. The CCD camera 32 can also be used to adjust the positions of the probe tip 411 and the sample 45. Hereinafter, the mirror 81, the half mirror 82, the short pass filter 83, and the half mirror 84 are collectively referred to as an auxiliary optical system 80.

The tuning fork cantilever 41 is a crystal resonator having a U-shape like a tuning fork, and includes a probe tip 411 at the tip. The probe tip 411 is close to the sample 45 and receives an atomic force from the sample 45. The tuning fork cantilever 41 is connected to the AFM controller 43 by a first wire 451 and a second wire 452. The drive signal is input to the tuning fork cantilever 41 from the AFM controller 43 via the first wire 451. The drive signal is a voltage that periodically varies in a sinusoidal manner, and the frequency of the drive signal is hereinafter referred to as drive frequency fd.

When a voltage is applied to the tuning fork cantilever 41, distortion occurs, and the tuning fork cantilever 41 vibrates as the applied voltage periodically fluctuates.

When the drive frequency fd coincides with the resonance frequency of the tuning fork cantilever 41, the vibration becomes maximum. However, the resonance frequency of the tuning fork cantilever 41 is affected by an external force, that is, an interatomic force from the sample 45. In addition, the tuning fork cantilever 41 outputs a current when a voltage is applied and the tuning fork cantilever 41 is distorted, and the current is output to the AFM controller 43 via the second wire 452.

The charge amplifier 42 is arranged in a second wire 452 connecting the tuning fork cantilever 41 and the AFM controller 43. The charge amplifier 42 amplifies the output of the tuning fork cantilever 41 and outputs the amplified output to the AFM controller 43. The AFM controller 43 includes a PLL 431, an amplification controller 432, and a phase shifter 433. The PLL 431 is a phase locked loop, and outputs a frequency to the amplification controller 432 so that a phase difference between a signal input from the tuning fork cantilever 41 via the second wire 452 and a reference signal becomes constant.

Further, the PLL 431 outputs a voltage or a current corresponding to a difference between the current resonance frequency of the tuning fork cantilever 41 calculated from the output of the tuning fork cantilever 41 and the reference resonance frequency of the tuning fork cantilever 41 to the lock-in amplifier 25 as a frequency deviation signal 71. The amplification controller 432 amplifies the signal output from the PLL 431 and outputs the amplified signal to the phase shifter 433. The phase shifter 433 outputs a sine wave of a voltage having a frequency designated by the PLL 431 and a reference phase to the tuning fork cantilever 41. The lock-in amplifier 25 performs lock-in detection of the frequency deviation signal 71 output from the AFM controller 43 by using the reference signal R output from the delay time controller 24. The lock-in amplifier 25 outputs the measurement result to the storage device 9. The lock-in detection by lock-in amplifier 25 is also referred to as “phase-sensitive detection”.

### Measurement Procedure

First, the operator arranges the sample 45 and adjusts the positions of the sample 45 and the tuning fork cantilever 41 while viewing the CCD camera 32. Next, the operator operates the AFM controller 43 and the lock-in amplifier 25. When the relative positions of the tuning fork cantilever 41 and the sample 45 are changed using an XYZ table (not shown), the interatomic force changes according to the distance between the probe tip 411 disposed at the tip of the tuning fork cantilever 41 and the sample 45, and the signal output from the AFM controller 43 changes. The operator determines a measurement point on the sample 45 to be subjected to time-resolved measurement, and fixes the relative position between the probe tip 411 and the measurement point. Then, the operator operates the trigger generator 21, the pump light generator 22, the probe light generator 23, and the delay time controller 24. The pump light and the probe light form a spot region having a diameter of several micro meter (μm) in the sample 45.

The operator sets the delay time controller 24 to a first delay time, e.g. T1, and starts the measurement. The delay time controller 24 periodically switches delay time between T1 and Tmax as described with reference to FIG. 2. The sample 45 is irradiated with the probe light after a lapse of T1 from the irradiation with the pump light. When the sample 45 is irradiated with the pump light, the peak of the excited state is reached after a very short period of time, and relaxation proceeds little by little and the excited state finally becomes a non-excited state. As will be described in detail later, the sample 45 applies a force to the tuning fork cantilever 41 in accordance with the excitation state to change the resonance frequency. The lock-in amplifier 25 measures and outputs the change in the resonance frequency.

Thereafter, the operator can measure the change in the resonance frequency with respect to the change in delay time by changing delay time to T2, T3, or the like. When delay time is Tmax, the sample 45 is irradiated with the probe light in the non-excited state. Therefore, the lock-in amplifier 25 evaluates the resonance frequency in each delay time based on the case where delay time is Tmax.

### Measurement Example

A measurement example in which measurement is performed using bulk tungsten selenide WSe2 as the sample 45 will be described. The LED light source 31 has 28 μW, a spot diameter of 200 μm, a wavelength of 550 to 750 nm, and an excitation density of about 90 pW/μm². The pump light and the probe light each have 1 mW, a spot diameter of about 5 μm, a center wavelength of 532 nm, and an excitation density of about 50 μW/μm². In the measurement, the AFM controller 43 was feedback-controlled so as to be higher than the resonance frequency by 1 Hz in the repulsion region. In this setup, the force acting between the probe tip 411 and the sample 45 corresponds to 10 nN or less. The amplitude of the tuning fork cantilever 41 is 4 nm.

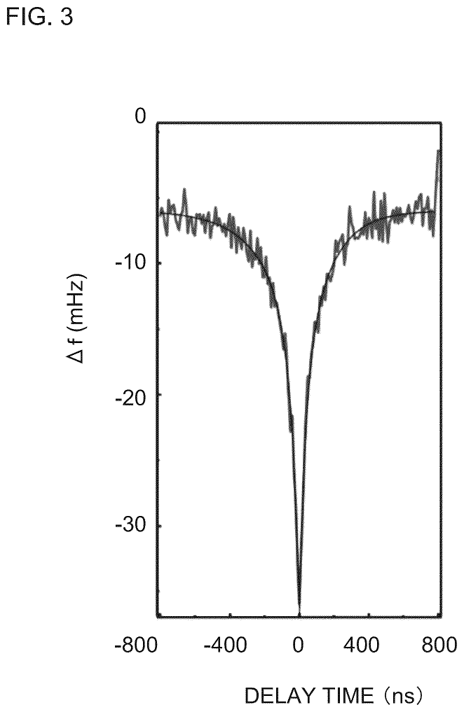

FIG. 3 is a diagram illustrating a measurement example. In this measurement, delay time td was varied between about ±1 microsecond, strictly from −800 nanoseconds to +800 nanoseconds. As shown in FIG. 3, time-resolved signals were successfully obtained at a very high S/N ratio. When the data was fitted with a two-component exponential function (A_{fast} exp (−t/T_{fast})+A_{slow} exp (−t/_{Tslow})), T_{fast} Was about 30 ns and T_{slow} was about 150 ns.

According to the first embodiment described above, the following effects can be obtained.
(1) The measurement system 1 includes: the pump light generator 22 that outputs pump light that is a pulse laser in accordance with an input reference pulse P1; the probe light generator 23 that outputs probe light that is a pulse laser in accordance with an input delay pulse P2; the reference pulse 21 and the delay pulse 24 that input trigger generator P1 and the delay time controller P2 to the pump light generator 22 and the probe light generator 23, repeatedly input signals by switching a delay time td that is a difference between a timing at which the reference pulse P1 is input to the pump light generator 22 and a timing at which the delay pulse P2 is input to the probe light generator 23 in a plurality of ways, and output the reference signal R to the lock-in amplifier 25 when delay time td is switched; and the auxiliary optical system 80 that guides the pump light and the probe light to the sample 45; the tuning fork cantilever 41 that has the probe tip 411 disposed in proximity to the sample 45 and is a crystal oscillator; the AFM controller 43 that applies a periodically varying voltage to the tuning fork cantilever 41 and outputs the voltage or current as a change amount signal corresponding to a change in a resonance frequency of the tuning fork cantilever 41; and the lock-in amplifier 25 that measures the change amount signal based on the reference signal R. Therefore, the optical excitation dynamics can be measured only by adding the light source unit 2 to existing microscope unit 3 including the tuning fork cantilever 41. Further, since the tuning fork cantilever 41 is used, an optical system for detecting probe vibration is not required, and the measurement system 1 can be used even in a complicated apparatus such as an ultrahigh vacuum chamber. Further, since the spring constant of the tuning fork cantilever 41 can be increased, the vibration amplitude can be reduced.
(2) The delay time controller 24 switches delay time td to a measurement delay time, such as first time T1, and reference delay time Tmax, which reference delay time is longer than the relaxation time of the excited state of the sample 45 excited by the pump light.
(3) The lock-in amplifier 25 measures the first change amount signal in a state where the delay time controller 24 sets first time T1 to the measurement delay time and sets Tmax to reference delay time, and measures the second change amount signal in a state where the delay time controller 24 sets second time T2 to the measurement delay time and sets Tmax to reference delay time.

### Modification 1

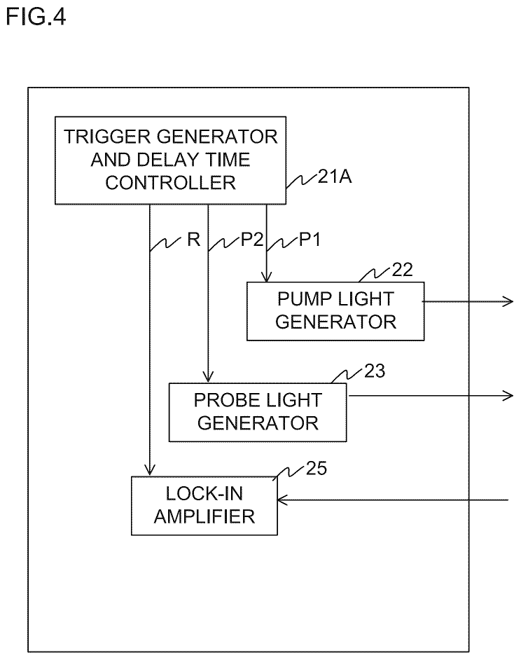

FIG. 4 is a diagram illustrating a light source unit 2A according to the first modification. Since the configuration other than light source unit 2A is the same as that of the first embodiment, description and explanation thereof will be omitted. In the present modification, a trigger generator and delay time controller 21A is provided instead of the trigger generator 21 and the delay time controller 24. The trigger generator and delay time controller 21A has the functions of the trigger generator 21 and the delay time controller 24. In other words, trigger generator and delay time controller 21A is formed by integrating the trigger generator 21 and the delay time controller 24. The trigger generator and delay time controller 21A outputs the reference pulse P1 to the pump light generator 22, outputs the delay pulse P2 to the probe light generator 23, and outputs the reference signal R to the lock-in amplifier 44. Since the operation of the trigger generator and delay time controller 21A is the same as the operation of the trigger generator 21 and the delay time controller 24 in the first embodiment described above, the description thereof will be omitted.

### Modification 2

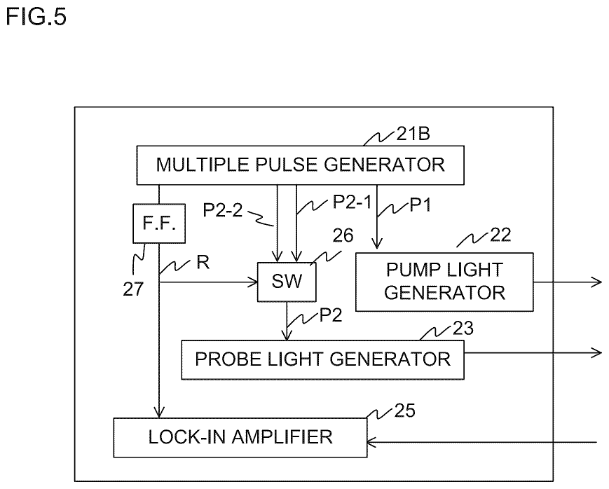

FIG. 5 is a diagram illustrating a light source unit 2B according to a second modification. Since the configuration other than light source unit 2A is the same as that of the first embodiment, description and explanation thereof will be omitted. the light source unit 2B includes a multiple pulse generator 21B, a switch 26, and a flip-flop 27 instead of the trigger generator 21 and delay time controller 24. multiple pulse generator 21B has a part of the functions of the trigger generator 21 and the delay time controller 24. That is, the multiple pulse generator 21B outputs the reference pulse P1, the first delay pulse P2-1, the second delay pulse P2-2, and the reference signal pulse Rp. The reference signal pulse Rp is a pulse signal indicating a timing at which the polarity of reference signal R is switched. In the first embodiment described above, the delay time controller 24 switches and outputs the first delay pulse P2-1 and the second delay pulse P2-2. However, the multiple pulse generator 21B according to the present modification outputs the first delay pulse P2-1 and the second delay pulse P2-2.

The flip-flop 27 receives the reference signal pulse Rp from the trigger generator 21 and outputs the reference signal R to the switch 26 and the lock-in amplifier 25. The flip-flop 27 is capable of outputting High and Low, and provides different outputs to the switch 26 and the lock-in amplifier 25 every time the reference signal pulse Rp is input from the trigger generator 21. The reference signal R input to the lock-in amplifier 25 is the same in the first embodiment and the present modification.

The switch 26 receives the first delay pulse P2-1 and the second delay pulse P2-2 from the trigger generator 21, and outputs one of them to the probe light generator 23. Which signal is output to the probe light generator 23 is determined by the reference signal R input from the flip-flop 27. For example, when the reference signal R is High, the switch 26 outputs the first delay pulse P2-1, and when the reference signal R is Low, the switch 26 outputs the second delay pulse P2-2. As described above, the configuration of the light source unit 2 is not limited to the configuration of the first embodiment, and may be the configuration illustrated in FIG. 5.

### Modification 3

In the first embodiment described above, the reference pulse P1 is input to the pump light generator 22 and the delay pulse P2 is input to the probe light generator 23. However, the delay pulse P2 may be input to the pump light generator 22 and the reference pulse P1 may be input to the probe light generator 23.

### Modification 4

The AFM controller 43 in the first embodiment described above employs a so-called FM-AFM that detects the frequency shift amount of the resonance frequency of the tuning fork cantilever 41. However, the AFM controller 43 may employ a so-called AM-AFM that detects a change in the vibration amplitude of the tuning fork cantilever 41 and controls the distance between the tuning fork cantilever 41 and the sample 45 using a feedback circuit so that the vibration amplitude becomes constant.

### Modification 5

In the first embodiment described above, the tuning fork cantilever 41, which is a tuning-fork type cantilever formed of a crystal oscillator, is used. However, a cantilever using a more general leaf spring may be used.

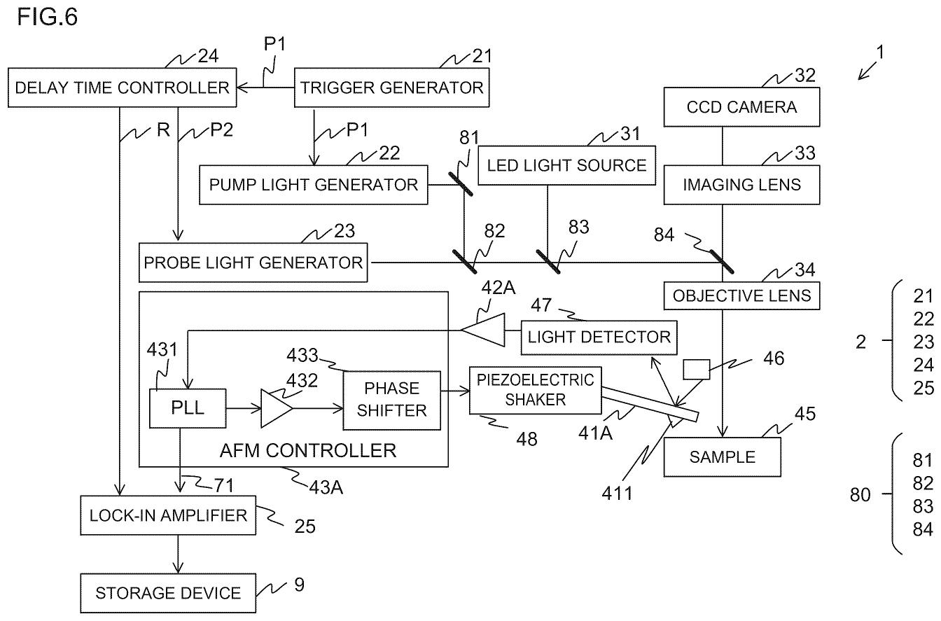

FIG. 6 is an overall configuration diagram of a measurement system 1 according to a fifth modification. The AFM unit 4 according to the present modification includes a leaf spring cantilever 41A, a light source 46, a light detector 47, an amplifier 42A, a piezoelectric shaker 48, an AFM controller 43A, and a sample stage (not illustrated).

The light source 46 irradiates the back surface of the leaf spring cantilever 41A with laser light, and the reflected light is detected by the light detector 47. The light source 46 and the light detector 47 use a so-called optical lever system. The leaf spring cantilever 41A is vibrated at a predetermined frequency by the piezoelectric shaker 48. The resonance frequency and amplitude of the leaf spring cantilever 41A are changed by the force received from the sample 45.

Changes in the frequency and amplitude of the vibration of the leaf spring cantilever 41A are detected by the light detector 47 as changes in the behavior of the reflected light. An output signal of the light detector 47 is amplified by the amplifier 42A and input to the AFM controller 43A. The configuration of the AFM controller 43A is the same as that of the first embodiment described above, and is different in that the output source of the input signal is changed from the tuning fork cantilever 41 to the light detector 47. Since the operation of the AFM controller 43A is the same as that of the first embodiment, the description thereof will be omitted. The AFM controller 43A performs feedback control using the output of the light detector 47, and causes the leaf spring cantilever 41A to vibrate by the piezoelectric shaker 48.

Although the vibration of the leaf spring cantilever 41A is detected by a so-called optical lever method in the present modification, a self-sensing cantilever may be used. In this case, for example, a piezo-resistor is built in the cantilever, the light source 46 and the light detector 47 are unnecessary, and a space for arranging a measuring instrument near the sample 45 is unnecessary.

### Second Embodiment

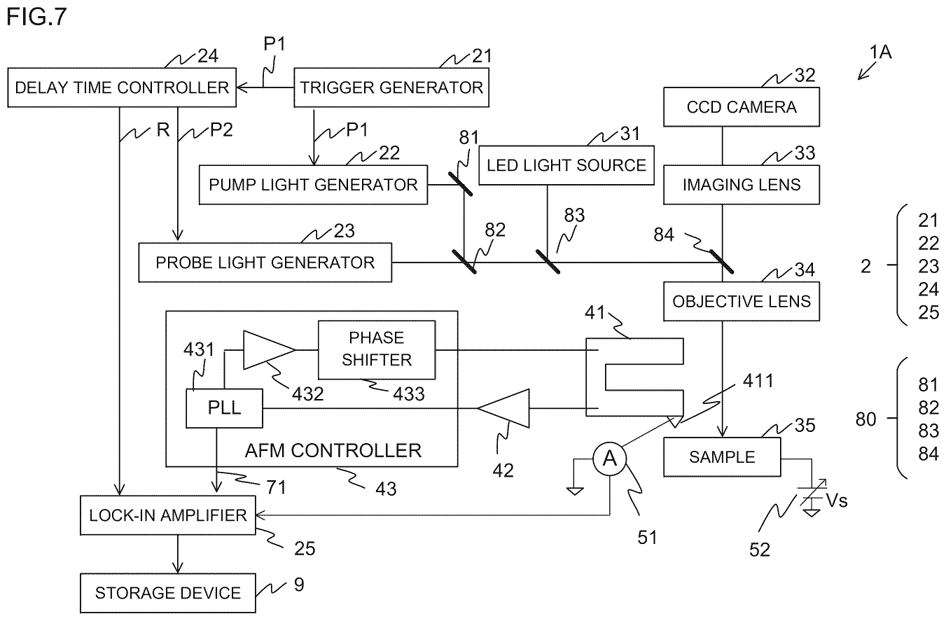

A second embodiment of the measurement system will be described with reference to FIGS. 7 to 9. In the following description, the same components as those of the first embodiment are denoted by the same reference numerals, and differences will be mainly described. Points not particularly described are the same as those in the first embodiment. The present embodiment is different from the first embodiment mainly in that the tunnel current is measured.

FIG. 7 is an overall configuration diagram of measurement system 1A. The measurement system 1A includes a current measurement section 51 and a voltage source 52 in addition to the configuration of the first example embodiment. The current measurement section 51 measures the tunnel current flowing through the probe tip 411, and the measured current is input to the lock-in amplifier 25 as a tunnel current signal 72. The tunnel current signal 72 is subjected to lock-in detection similarly to the frequency deviation signal 71 output from the AFM controller 43, and is output to the storage device 9. Since the current measurement section 51 measures a tunneling current, it can also be referred to as a “tunneling current measurement section”.

The voltage source 52 applies bias voltage Vs, which is an arbitrary DC voltage, to the sample 45. The state of the sample 45 is statically changed by applying bias voltage Vs, and the sample 45 can be measured at different potentials.

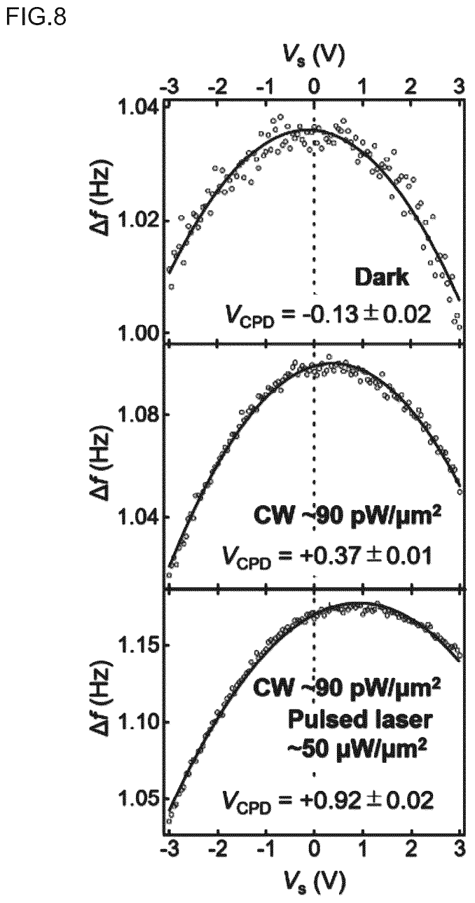

FIG. 8 is a diagram illustrating force spectroscopy. Specifically, the illumination and bias voltage Vs were varied to measure the change in resonant frequency. Among the three diagrams shown in FIG. 8, the upper diagram shows a case where there is no illumination (hereinafter also referred to as a “dark state”), the middle diagram shows a case where the generated light of the LED light source 31 is irradiated (hereinafter also referred to as a “weakly excited state”), and the lower diagram shows a case where the generated light of the LED light source 31 and the pump light generator 22 is irradiated (hereinafter also referred to as a “strongly excited state”). The bias voltage Vs was varied from −3V to +3V. In the middle part and the bottom part of FIG. 8, the LED light source 31 is always ON, and the pump light generator 22 outputs at 500 kHz. The intensity and the like of the LED light source 31 and the pump light are the same as those in the first embodiment. However, in this measurement, delay time modulation is not performed, and the frequency deviation signal 71 and the tunnel current signal 72 are measured as they are without performing the lock-in detection.

The contact potential difference (Vcpd) under the three illumination conditions was derived by fitting each of the obtained Δf-Vs curves with a quadratic function. The dark state is −0.13±0.02 V, the weakly excited state is 0.37±0.01 V, and the strongly excited state is 0.92±0.02 V. This is called Surface Photo Voltage.; SPV. SPV is the difference in Vcpd with and without illumination, creating a force between the probe tip 411 and the sample 45.

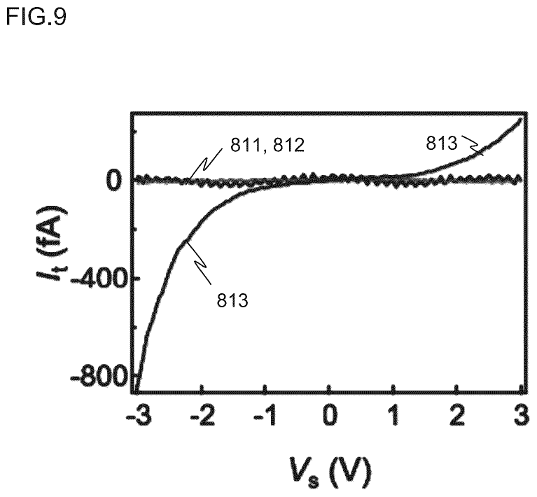

FIG. 9 is a diagram illustrating an IV curve. The IV curve was obtained by measuring the current flowing between the probe tip 411 and the sample 45 by the current measurement section 51 while measuring the Δf-Vs curve under three illumination conditions as in FIG. 8. FIG. 9 illustrates a first curve 811 that is an IV curve in the dark state, a second curve 812 that is an IV curve in the weakly excited state, and a third curve 813 that is an IV curve in the strongly excited state. The first curve 811 and the second curve 812 almost overlap each other in the entire region of −3 V to +3 V, and are 0 A at which almost no current flows. On the other hand, in the strongly excited the third curve 813, a negative current flowed when bias voltage Vs was negative, and a positive current flowed when bias voltage Vs was positive. This result coincides with the measurement result shown in FIG. 8.

According to the second embodiment described above, the following effects can be obtained.
(4) The measurement system 1A includes the current measurement section 51 that measures a tunnel current flowing through the probe tip 411. Therefore, the tunnel current can be measured in parallel with the measurement of the interatomic force by the AFM.

### Third Embodiment

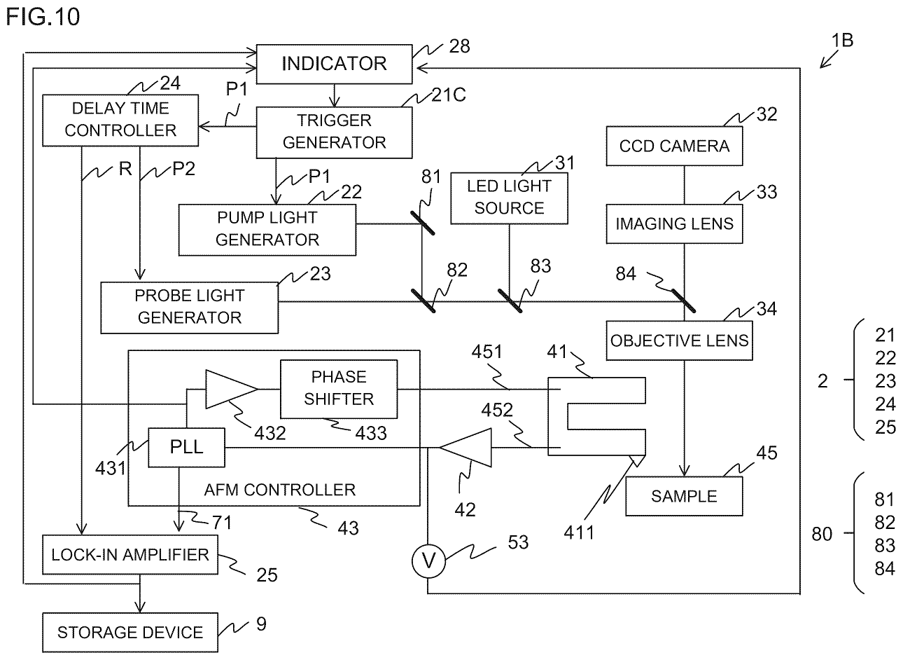

A third embodiment of the measurement system will be described with reference to FIGS. 10 to 13. In the following description, the same components as those of the first embodiment are denoted by the same reference numerals, and differences will be mainly described. Points not particularly described are the same as those in the first embodiment. The present embodiment is different from the first embodiment mainly in that an indicator is further provided.

FIG. 10 is an overall configuration diagram of measurement system 1B. The measurement system 1B further includes an indicator 28 in addition to the configuration in the first example embodiment. The trigger generator 21C in the present embodiment outputs the reference pulse P1 at a frequency specified by the indicator 28, not at a predetermined frequency. The phase, that is, the timing at which the reference pulse P1 is output is also specified by the indicator 28. The indicator 28 is a computer having an arithmetic function, and can be realized by a combination of a general-purpose personal computer, a microcomputer, a logic circuit, or the like and an interface circuit. For example, the indicator 28 includes a central processing unit (CPU), a ROM that stores a program, and a RAM that is a place where the central processing unit develops the program stored in the ROM to execute the program.

The indicator 28 receives outputs of the PLL 431, the lock-in amplifier 25, and the voltmeter 53. The voltmeter 53 measures a voltage output from the charge amplifier 42. However, the voltmeter 53 may be built in the indicator 28. The indicator 28 determines a frequency and a phase at which the trigger generator 21C outputs the reference pulse P1, and instructs the trigger generator 21C. The trigger generator 21C changes the frequency and phase of the output of the reference pulse P1 based on the output of the indicator 28.

In the present embodiment, the frequency of the reference pulse P1 is an integral multiple or an integral fraction of the vibration frequency of the tuning fork cantilever 41. Hereinafter, a value obtained by dividing the frequency of the reference pulse P1 by the vibration frequency of the tuning fork cantilever 41 is referred to as specified magnification W. When specified magnification W is larger than 1, the frequency of reference pulse P1 is larger than the vibration frequency of the tuning fork cantilever 41, and when specified magnification W is smaller than 1, the frequency of the reference pulse P1 is smaller than the vibration frequency of the tuning fork cantilever 41. The specified magnification W is an integer such as “1”, “2”, “3”, or a decimal such as “½”, “⅓”, “¼”, . . . The specified magnification W is set in advance by the user.

The indicator 28 obtains cantilever frequency f and cantilever phase p from the output of the voltmeter 53 or the output of the PLL 431. For example, the indicator 28 can obtain the cantilever frequency f and the cantilever phase p by detecting, as a trigger, that the output of the charge amplifier 42 or the PLL 431, which changes sinusoidally, exceeds a predetermined threshold. The indicator 28 may receive at least one of the output of the voltmeter 53 and the output of the PLL 431, and may not receive the output of the lock-in amplifier 25. That is, the indicator 28 performs any one of a first operation using the output of the voltmeter 53, a second operation using the output of the PLL 431, a third operation using the outputs of the voltmeter 53 and the lock-in amplifier 25, and a fourth operation using the outputs of the PLL 431 and the lock-in amplifier 25.

In the first operation and the second operation, the indicator 28 obtains cantilever frequency f and cantilever phase p using the output of the voltmeter 53 or the output of the PLL 431 as described above. In the third operation and the fourth operation, a value obtained by adding a frequency deviation corresponding to the output value of the lock-in amplifier 25 to cantilever frequency f obtained using the output of the voltmeter 53 or the output of the PLL 431 is set as the final cantilever frequency f. The third operation and the fourth operation are useful when noise is large and it is difficult to calculate an accurate frequency from the output of the voltmeter 53 or the PLL 431.

The indicator 28 causes trigger generator 21C to output the reference pulse P1 at a frequency obtained by multiplying cantilever frequency f obtained in any one of the first to fourth operations by the specified magnification W. For example, when cantilever frequency f is “1234 Hz” and specified magnification W is “10”, the output frequency of the reference pulse P1 is “12340 Hz”. For example, when cantilever frequency f is “12 kHz” and specified magnification W is “0.5”, the output frequency of the reference pulse P1 is “6 kHz”.

The indicator 28 obtains cantilever phase p, for example, as follows. Although the case of using the output of voltmeter 53 will be described here, the same procedure is applied to the case of using the output of the PLL 431. The indicator 28 measures the minimum value and the maximum value of the output of the voltmeter 53 that changes sinusoidally. Then, cantilever phase p is calculated using the timing at which the output of the voltmeter 53 exceeds a predetermined value between the minimum value and the maximum value and the reciprocal of cantilever frequency f. However, cantilever phase p may be calculated as a timing at which the reference pulse P1 is to be output next. The indicator 28 determines the next timing of outputting the reference pulse P1, for example, as follows.

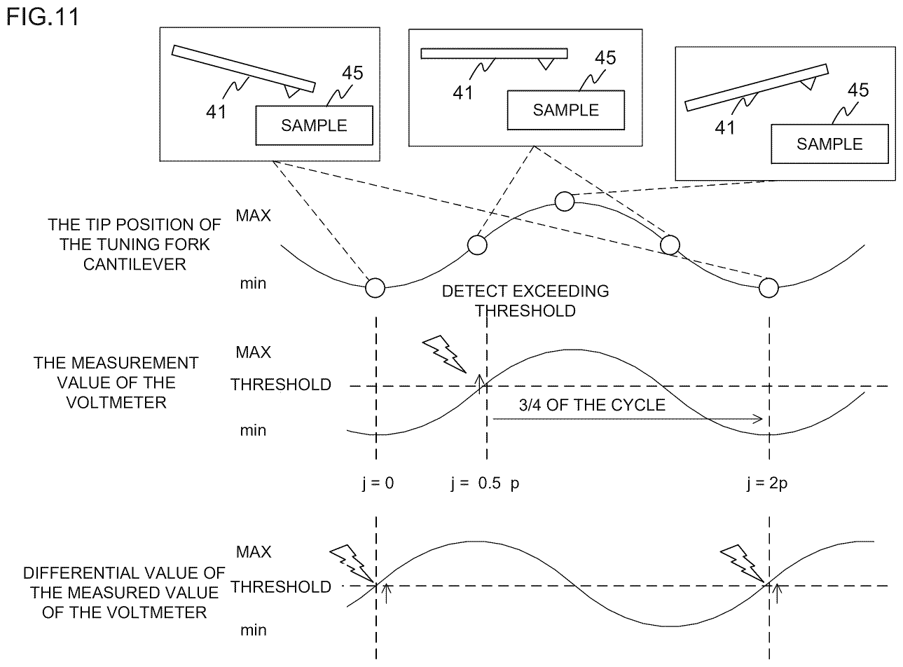

FIG. 11 is a schematic diagram illustrating output timing of the reference pulse P1. The upper part of FIG. 11 shows the tip position of the tuning fork cantilever 41, and the middle part of FIG. 11 shows the measurement value of the voltmeter 53. The lower part of FIG. 11 will be described later. In FIG. 11, the tuning fork cantilever 41 is shown in a plate spring shape for convenience of drawing. As shown in FIG. 11, the tip position of the tuning fork cantilever 41 and the measurement value of the voltmeter 53 are synchronized. Here, the average value of the minimum value and the maximum value of the output of voltmeter 53 is set as the threshold value. The timing at which the tip position of the tuning fork cantilever 41 is at the lowest position is defined as “0” of the phase. In this case, the timing at which the measured value exceeds the threshold is when the phase is “0.5π”, and the timing at which the phase becomes “2π”or “0” next is after ¾ cycle. Since the cycle is obtained as the reciprocal of the calculated cantilever frequency f, the indicator 28 can calculate the timing at which the reference pulse P1 is to be output next.

The measured voltage value may be differentiated and used to determine the output timing of the reference pulse P1. The lower part of FIG. 11 shows differential values obtained by differentiating the measurement values shown in the middle part of FIG. 11. The differential value may be calculated by time-differentiating the voltage measurement value by the indicator 28, or may be obtained by measuring an output of a differentiating circuit. The differential value is 90 degrees out of phase with the measured value. Therefore, the indicator 28 detects that the threshold value set in the vicinity of 0 V is exceeded from the minus side to the plus side, and immediately outputs the reference pulse P1 to the trigger generator 21C upon detection. Although two methods of calculating the timing at which the reference pulse P1 is to be output have been described here, other methods may be used.

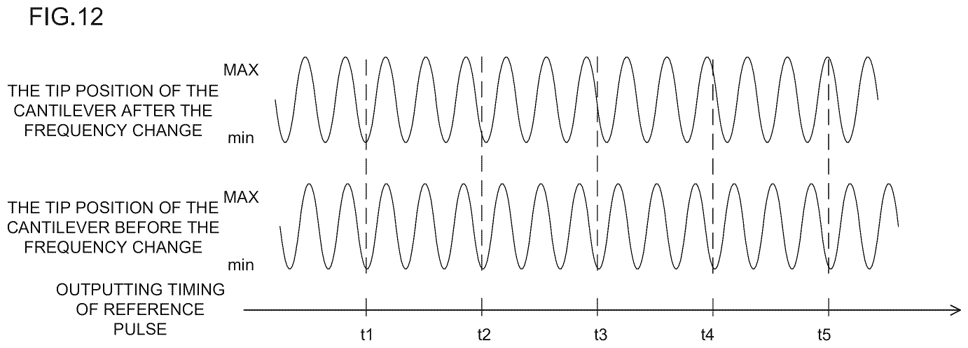

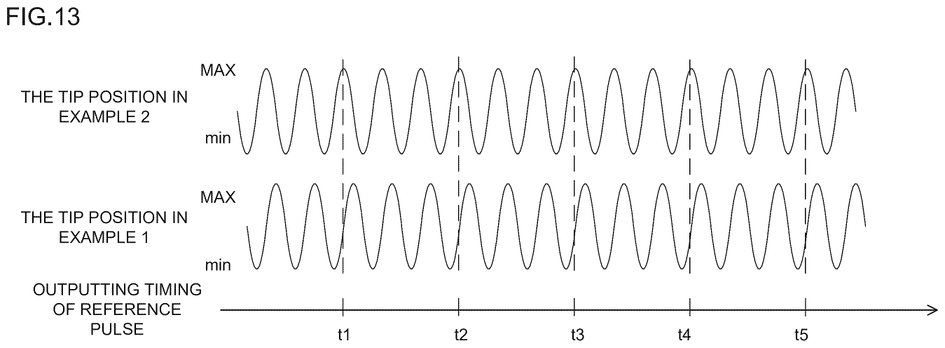

The necessity of adjusting the frequency and the phase of the reference pulse P1 will be described with reference to FIGS. 12 and 13. In any of the embodiments and modifications described in this specification, an atomic force, a surface photo-voltage (SPV) induced force, and an image dipole force act on the tuning fork cantilever 41 and the leaf spring cantilever 41A. Among them, the atomic force is not affected by the excited state of the sample 45 by the pump light or the probe light, but the SPV induced force and the image dipole force are closely correlated with the excited state of the sample 45. Therefore, in order to measure the SPV induced force and the image dipole force with high sensitivity, it is desirable that the tuning fork cantilever 41 and the probe tip 411 of the leaf spring cantilever 41A are close to the sample 45 in a state where the sample 45 is excited. The tuning fork cantilever 41 and the leaf spring cantilever 41A vibrate, and the distance between the probe tip 411 and the sample 45 changes in a substantially constant cycle.

FIG. 12 is a diagram illustrating a problem that occurs when the frequency of the reference pulse P1 is not adjusted. In FIG. 12, time passes from left to right in the drawing. Times t1, t2, t3, t4, and t5 illustrated in the lower part of FIG. 12 are timings at which the reference pulse P1 is output. However, on the time axis of the drawing, delay time td is sufficiently short, and the sample 45 is irradiated with the pump light and the probe light at substantially the same timing as the reference pulse P1. The output cycle of the reference pulse P1 in this figure is constant, and the time interval between time t1 and time t2, the time interval between time t2 and time t3, the time interval between time t3 and time t4, and the time interval between time t4 and time t5 are equal.

The middle part of FIG. 12 shows the tip position of the cantilever before the frequency change. In other words, the middle part of FIG. 12 illustrates a temporal change in the distance between the probe tip 411 and the sample 45. The vibration frequency of the cantilever before the frequency change is, for example, 300 kHz, which is an integral multiple of 100 kHz that is the frequency at which the reference pulse P1 is output. In this example, specified magnification Wis “⅓”. In this case, when the tip position of the cantilever is closest to the sample 45 at time t1, the tip position of the cantilever is closest to the sample 45 at any of times t2, t3, t4, and t5, and the SPV induced force and the image dipole force can always be measured with high sensitivity.

The upper part of FIG. 12 shows the tip position of the cantilever after the frequency change. The term “after the frequency change” as used herein means after the vibration frequency of the cantilever has changed due to the influence of the atomic force, the SPV induced force, and the image dipole force. In a case where the output timing of the reference pulse P1 does not change, even when the tip position of the cantilever is closest to the sample 45 at time t1, the phase shift due to the mismatch of the periods becomes remarkable as time elapses. In the example shown in FIG. 12, at time t5, reference pulse P1 is output at a position where the tip of the cantilever is farthest from the sample 45. Therefore, when the frequency of the reference pulse P1 is not adjusted, even if the sample 45 is excited, it may be difficult to detect the SPV induced force and the image dipole force due to the long distance, and there is a problem in that the measurement sensitivity decreases.

FIG. 13 is a diagram illustrating a problem that occurs when the phase of reference pulse P1 is not adjusted. FIG. 13 illustrates differences from FIG. 12. Since the times t1 to t5 shown in the lower part of FIG. 13 are the same as those in FIG. 12, the description thereof will be omitted. The middle part and the upper part of FIG. 13 show the time series change of the tip position of the cantilever in Example 1 and Example 2. The frequencies of Example 1 and Example 2 are the same as those before the frequency change in FIG. 12, and specified magnification W is “⅓”. Therefore, the output timing of the reference pulse P1 is the same phase in each example. When the phase is not explicitly adjusted, even if the frequency of the reference pulse P1 is an integral multiple or an integral fraction of the vibration frequency of the tuning fork cantilever 41, it is only guaranteed that the phase of the tip position of the cantilever at the output timing of the reference pulse P1 is constant.

Therefore, the reference pulse P1 may be output every time when the tip of the cantilever is at the substantially center position as in Example 1, or the reference pulse P1 may be output when the tip of the cantilever is at the farthest position from the sample 45 as in Example 2. In Example 1, the sensitivity of the measurement of the SPV induced force and the image dipole force is low, and in Example 2, the SPV induced force and the image dipole force can hardly be measured. Therefore, when the phase of the reference pulse P1 is not adjusted, even if the sample 45 is excited, it may be difficult to detect the SPV induced force and the image dipole force due to the long distance, and there is a problem in that the measurement sensitivity decreases.

As described with reference to FIGS. 12 and 13, when the frequency or the phase of the reference pulse P1 is not adjusted, there is a problem that the measurement sensitivity of the detection of the SPV induced force and the image dipole force is lowered. However, the trigger generator 21C in the present embodiment increases or decreases the frequency at which the reference pulse P1 is output based on the output of the lock-in amplifier 25, and changes the phase of the reference pulse P1 based on the output of the voltmeter 53. Therefore, the above problem does not occur, and the SPV induced force and the image dipole force can be measured with high sensitivity.

According to the third embodiment described above, the following effects can be obtained.
(5) The measurement system 1B includes the indicator 28 that causes the trigger generator 21C and the delay time controller 24 to output the reference pulse P1 and the delay pulse P2 based on the movement of the tuning fork cantilever 41. Therefore, a change in the frequency of the tuning fork cantilever 41 can be detected with high sensitivity.
(6) The indicator 28 causes the trigger generator 21C and the delay time controller 24 to outputs the reference pulse P1 and the delay pulse P2 at a frequency that is an integral multiple of the vibration frequency of the tuning fork cantilever 41 or at a frequency that is an integral fraction of the vibration frequency of the tuning fork cantilever 41.
(7) The indicator 28 adjusts the phases of reference pulse P1 and delay pulse P2 so that the sample 45 is irradiated with the pump light and the probe light when the tip of the tuning fork cantilever 41 comes closest to the sample 45.

### Modification 1 of Third Embodiment

In the third embodiment, the trigger generator 21C and the indicator 28 are described as different hardware devices. However, the trigger generator 21C and the indicator 28 may be realized by the same hardware device. The trigger generator 21C, the indicator 28, and the delay time controller 24 may be implemented by the same hardware device. The indicator 28 may designate only a frequency at which the reference pulse P1 is output to the trigger generator 21C.

### Modification 2 of Third Embodiment

The measurement system 1B may comprise a current amplifier instead of the charge amplifier 42. Even when charge amplifier 42 is changed to the current amplifier, the same operation and effect can be obtained with the same configuration.

In each of the above-described embodiments and modifications, the configuration of the functional block is merely an example. Some functional configurations illustrated as separate functional blocks may be integrally configured, or a configuration represented by one functional block diagram may be divided into two or more functions. Further, a part of the functions of each functional block may be included in another functional block.

The above-described embodiments and modifications may be combined. In particular, the fifth modification of the first embodiment may be combined with the third embodiment. Although various embodiments and modifications have been described above, the present invention is not limited to these contents. Other embodiments conceivable within the scope of the technical idea of the present invention are also included in the scope of the present invention.

### REFERENCE SIGNS LIST

1, 1A: measurement system
2, 2A, 2B: light source unit
3 microscope unit
4 AFM unit
21, 21C: trigger generator
21A trigger generator and delay time controller.
21B multiple pulse generator.
22 pump light generator.
23 probe light generator.
24 delay time controller.
25 lock-in amplifier.
28 indicator.
35 sample:
41 tuning fork cantilever.
43 FMAM Controller
44 lock-in amplifier.
51 current measurement section:
411 probe tip:

1. A measurement system comprising:
a first laser device for outputting a pump light as a pulse laser in response to an input first signal;
a second laser device for outputting a probe light as a pulse laser in response to an input second signal;
a trigger generator and delay time controller for inputting the first signal and the second signal to the first laser and the second laser, repeatedly inputting the first signal and the second signal by switching a variable delay value which is a difference between a timing of inputting the first signal to the first laser and a timing of inputting the second signal to the second laser in a plurality of ways, and outputting a reference signal to a lock-in amplifier when switching the variable delay value;
an auxiliary optical system for guiding the pump light and the probe light to sample;
a cantilever having an probe tip disposed proximate to the sample; and
a controller for applying a periodically varying voltage to the cantilever and outputting a change amount signal which is a voltage or a current corresponding to a change in the resonance frequency of the cantilever,
wherein the lock-in amplifier measures the change amount signal based on reference signal.

2. The measuring system according to claim 1,:
wherein the trigger generator and delay time controller switches the variable delay value to a delay time for measurement and a reference delay time, and the reference delay time is a time longer than a time for relaxation of an excited state in which sample is excited by the first laser.

3. The measuring system according to claim 2,
wherein the lock-in amplifier measure a first change amount signal in a state where trigger generator and delay time controller sets a first value to the measuring delay time and sets a predetermined value to reference delay time; and
wherein the lock-in amplifier measure a second change amount signal in a state where trigger generator and delay time controller sets a second value to the measuring delay time and sets the predetermined value to reference delay time.

4. The measuring system according to claim 1, further comprising:
a tunnel current measurement section configured to measure a tunnel current flowing through probe tip.

5. The measuring system according to claim 1,
wherein the cantilever is formed of a quartz oscillator and has a tuning fork shape.

6. The measuring system according to claim 1, further comprising:
a indicator that causes trigger generator and delay time controller to output the first signal and the second signal based on movement of the cantilever.

7. The measuring system according to claim 6,
wherein the indicator outputs the first signal and the second signal at a frequency that is an integral multiple of a vibration frequency of the cantilever or at a frequency that is an integral fraction of the vibration frequency of the cantilever.

8. The measuring system according to claim 7,
wherein indicator adjusts phases of the first signal and the second signal so that the sample is irradiated with the pump light and the probe light when the tip of the cantilever is closest to the sample.

9. A measuring method executed by a measuring system comprising a first laser device for outputting pump light which is a pulse laser in response to a first signal inputted thereto, a second laser device for outputting probe light which is a pulse laser in response to a second signal inputted thereto, an auxiliary optical system for guiding the pump light and the probe light to a sample, a cantilever having probe tip disposed in proximity to the sample, and lock-in amplifier, the measuring method comprising:
inputting the first signal and the second signal to the first laser device and the second laser device, respectively;
repeatedly inputting the first signal and the second signal by switching a variable delay value, which is a difference between a timing at which the first signal is input to the first laser device and a timing at which the second signal is input to the second laser, to a plurality of values; and
outputting a reference signal to the lock-in amplifier when switching the variable delay value; and
applying a periodically varying voltage to the cantilever and outputting a change amount signal which is a voltage or a current corresponding to a change in a resonance frequency of the cantilever;
measuring, by the lock-in amplifier, the change-amount signal by phase-sensitive detection using reference signal.

10. The measuring method according to claim 9, further comprising:
input step of inputting the first signal and the second signal to the first laser and the second laser based on the movement of the cantilever.

11. The measuring method according to claim 10,
wherein in the input step, the first signal and the second signal are input at a frequency that is an integral multiple of a vibration frequency of the cantilever or at a frequency that is an integral fraction of the vibration frequency of the cantilever.

12. The measuring method according to claim 11,
wherein in the input step, the phases of the first signal and the second signal are adjusted so that the sample is irradiated with the pump light and the probe light when the tip of the cantilever is closest to the sample.
